(19) United States
(12) Patent Application Publication
(10) Pub. No.: US 2004/0072939 A1
(43) Pub. Date: Apr. 15, 2004

(54) Viscosity modifying agents and water reducers

(76) Inventors: Charles R. Cornman, Maynard, MA (US); David William Hughes, Warrington (GB); Ara Avedis Jeknavorian, Chelmsford, MA (US); Hideo Koyata, Waltham, MA (US); Ding Feng Shen, Ashland, MA (US); Chia-Chih Ou, Lexington, MA (US)

Correspondence Address: Craig K. Leon, W.R. Grace & Co.-Conn., 62 Whittemore Ave., Cambridge, MA, 02140-1692, US

(21) Appl. No.: 10/269,554

(22) Filed: Oct. 11, 2002

(51) Int. Cl. C08L 1/00

(52) U.S. Cl. 524/502

(57) ABSTRACT

The present invention relates to a process for making a stable suspension comprising a polycarboxylate superplasticizer and a viscosity modifying agent for modifying a hydratable cementitous composition. A composition for modifying cementitious compositions, as well as the cementitious compositions, are also described herein.

### FIELD OF THE INVENTION

The present invention relates to admixtures for modifying cementitious compositions, and more particularly to a novel process for making stable suspensions having a viscosity modifying agent, polycarboxylate superplasticizer, and lignosulfonic acid or salt thereof.

### BACKGROUND OF THE INVENTION

It is known that polymeric carbohydrates, such as gums and cellulose derivatives, can increase the viscosity of cementitious materials. For example, a microbial carbohydrate, such as welan gum, as well as naturally occurring biopolymers, have been used for altering the rheology of certain cementitious mixtures.

Another such biopolymer is S-657, which is a microbial carbohydrate described in U.S. Pat. No. 5,175,278 of Peik et al. In U.S. Pat. No. 6,110,271, Skaggs et al. disclosed that the microbial polysaccaride S-657 compared favorably to welan gum when incorporated into cementitious systems such as Portland cement.

Biopolymers such as welan gum and S-657 are difficult to dispense at the application site. The preferred mode for dispensing such biopolymers at ready-mix concrete plants, into ready-mix trucks, or at construction sites is by employing a flowable liquid mixture that can be pumped and metered into the cementitious mixture. However, solutions of welan gum, S-657, and other biopolymers are highly viscous and consequently difficult to dispense at high concentrations. Further dilution can cause either further viscosifying of the solution due to swelling of the biopolymer, or separation of partially soluble biopolymer particles from the bulk solution.

One remedy is to formulate a suspension to prevent hydration of the polymeric carbohydrate. In U.S. Pat. Nos. 6,309,455 and 6,106,603, Skaggs et al. taught that the biopolymers could be uniformly dispersed by wet milling the biopolymer in a solution of sulfonated naphthalene, sulfonated melamine, or modified lignosulfonate to form an extremely fine particle size (e.g., from about 3 microns to about 500 microns).

Another remedy is to employ further rheology control agents. For example, in U.S. Pat. Nos. 6,221,152 and 6,117,226, Dial et al. disclosed that welan gum could be dispersed in sulfonated naphthalene, sulfonated melamine, and modified lignosulfate. This was subsequently dispersed in a rheological control agent, which was an insoluble microbially-produced cellulose fiber composition.

The foregoing prior art remedies are not practical for commercial purposes, however, because the wet milling process increases cost and production time, and the use of additional rheology control agents further increases costs.

While it may be surmised that biopolymers such as welan gum and S-657 can be suspended directly into modified lignosulfonate, melamine sulfonate formaldehyde copolymer (MSFC), or naphthalene sulfonate formaldehyde copolymer (NSFC), the present inventors discovered that the resultant solutions are not suitable for commercial use. In other words, a suspension of S-657 in MSFC or NSFC will separate upon standing overnight. Furthermore, if welan gum or S-657 is suspended in a modified lignosulfonate, the viscosity of the liquid is found to increase over time such that the liquid ultimately becomes difficult or impossible to dispense as a practical matter.

It has also been found that polycarboxylate superplasticizers lead to similar instability when used as carriers for the biopolymers. In World Patent Application PCT/US99/04915 (International Publication Number WO 99/44966), Langton et al. taught that a carrier liquid of a polycarboyxlate superplasticizer could be used to suspend and maintain welan gum, and to keep the biopolymer in a hydration-free state, such that the resultant product could be dispensed into a cementitious mixture. However, the present inventors have discovered that while the resultant product appeared stable at the time of preparation, the product separated upon standing overnight and was therefore not suitable for typical commercial/industrial usage.

One of the hindrances to preparing stable suspensions of biopolymers is the slow addition rate occasioned by the hydration and gelling of the biopolymer, during addition of the biopolymer into the liquid carrier, or during addition of the liquid carrier into biopolymer.

Hence, a novel process for obtaining a stable, liquid-dispensable viscosity modifying agent is needed for use in modifying hydratable cementitious compositions to which water reducers, such as polycarboxylate superplasticizers, are to be added.

### SUMMARY OF THE INVENTION

In surmounting the disadvantages of prior art approaches and compositions, the present invention provides a novel process for making a stable rheology modifier, preferably of the biopolymer polysaccharide type, and water reducers, preferably of the polycarboxylate superplasticizer type, for use in modifying cementitious mixtures.

An exemplary process of the present invention comprises: forming a first suspension by mixing a viscosity modifying agent (“VMA”) and a polycarboxylate superplasticizer (“PCS”) solution, which preferably comprises the polycarboxylate polymer in the amount of 10-60% by weight solids in solution, in a ratio wherein weight of VMA to weight of PCS solution is not less than 1:100 and not greater than 1:3, the VMA being uniformly suspended within the PCS in the first suspension; forming a second suspension by mixing the first suspension with an aqueous lignosulfonate solution comprising water and a lignosulfonic acid or salt thereof (“LS”), the LS being present in the solution in a concentration of 30% to 70% dry weight, and the aqueous lignosulfonate solution having a volume not less than 1.5 times volume of the first suspension and having a volume not greater than 10 times volume of the first suspension.

Preferably, the second suspension has resultant viscosity of 500 to 10,000 centipoise (cps) at a shear rate of 1.4/s and at an ambient temperature of ˜25° C., and the viscosity modifying agent is present in the second (or resultant) suspension in a concentration of 0.5% to 5.0% dry weight by weight of solution.

The preferred viscosity modifying agent (“VMA”) is biopolymer polysaccharide S-657, and the preferred polycarboxylate superplasticizer is a comb polymer having pendant oxyalkylene groups.

The present invention also provides compositions obtained by the above-described process, as well as methods for modifying hydratable cementitious compositions using the compositions. Further advantages and features of the invention are described in further detail hereinafter.

### BRIEF DESCRIPTION OF THE DRAWING

The following detailed description may be more readily appreciated when considered in conjunction with the appended drawings, wherein

FIG. 1 is a graph illustration of viscosity over time of a composition provided by a PRIOR ART procedure whereby a viscosity-modifying agent is incorporated into a lignosulfonate to form a paste/slurry, and then diluted with lignosulfonate and water;

FIG. 2 is a graphic illustration of viscosity over time of a composition provided by an exemplary procedure of the present invention, whereby a viscosity modifying agent is mixed with a polycarboxylate superplasticizer to form a first suspension, and then this first suspension is incorporated into a lignosulfonate; and

FIG. 3 is a graphic illustration of the effect of the mixture composition on the viscosity of suspensions.

### DETAILED DESCRIPTION OF EXEMPLARY EMBODIMENTS

The present invention provides a process for making a suspension comprising a viscosity modifying agent and a polycarboxylate superplasticizer for modifying hydratable cementitious compositions.

The term “cementitious composition” as may be used herein includes pastes (or slurries), mortars, and grouts, such as oil well cementing grouts, shotcrete, and concrete compositions comprising a hydraulic cement binder. The terms “paste”, “mortar” and “concrete” are terms of art: pastes are mixtures composed of a hydraulic cement binder (usually, but not exclusively, Portland cement, Masonry cement, Mortar cement, and/or gypsum, and may also include limestone, hydrated lime, fly ash, granulated blast furnace slag, and silica fume or other materials commonly included in such cements) and water; mortars are pastes additionally including fine aggregate (e.g., sand), and concretes are mortars additionally including coarse aggregate (e.g., crushed rock or gravel). The cement compositions tested in this invention are formed by mixing required amounts of certain materials, e.g., a hydraulic cement, water, and fine or coarse aggregate, as may be applicable to make the particular cement composition being formed.

Exemplary viscosity modifying agents (which may be referred to using the acronym “VMA”) contemplated for use in the present invention include but are not limited to: (a) biopolymer polysaccharides selected from the group consisting of welan gum, S-657, xanthan, rhamsan, gellan, dextran, pullulan, curdlan, and derivatives thereof; (b) marine gums selected from the group consisting of algin, agar, carrageenan, and derivatives thereof; (c) plant exudates selected from the group consisting of locust bean, gum arabic, gum Karaya, tragacanth, Ghatti, and derivatives thereof, (d) seed gums selected from the group consisting of guar, locust bean, okra, psyllium, mesquite, and derivatives thereof; and (e) starch-based gums selected from the group consisting of ethers, esters, and derivatives thereof (See e.g., U.S. Pat. No. 6,1110,271 at Column 3, lines 38-46).

Most preferred are the biopolymer polysaccharides such as welan gum, and most preferred of these is biopolymer polysaccharide S-657 which is commercially available from CP Kelco, U.S., Inc. of San Diego, Calif.

The terms “lignosulfonic acid or the salt thereof” and “lignosulfonate” as may be used herein (and which may be referred to using the acronym “LS”), shall include the sulfonated derivatives of lignin derived from the sulfite pulping process or from the kraft pulping process.

The term “polycarboxylate superplasticizer” (which may be referred to herein using the acronum “PCS”) means and includes polymers or copolymers, and solutions thereof, preferably having a comb structure, which contain groups for attaching to cement particles and groups for dispersing the attached cement particle within an aqueous environment. Preferably, the PCS has a comb polymer structure having (i) carboxylic acid anhydride, free carboxylic acid or its ammonium, alkali or alkaline earth metal salt of carboxylic acid units; and (ii) C₂-C₅ oxyalkylene units therein and wherein the carboxylic acid units or oxyalkylene units are pendant to the polymer backbone structure and wherein the oxyalkylene units provide a majority of the molecular weight of the comb polymer. The preferred amount of polymer or copolymer in solution is 10-60%, and more preferably 20-50%, by weight solids.

Exemplary polycarboxylate superplasticizers of the invention may have a polymer structure formed from units that can be generally represented by formula I

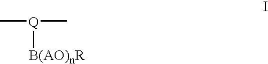

wherein Q is a fragment of the polymer backbone chain such as a hydrocarbon fragment of a residual of an ethylenic group which has a pendant group represented by B(AO)ₙR; B represents a tying group which covalently bonds the (AO)ₙR′ group to the hydrocarbon polymer backbone chain, the tying group B may be selected from carboxylic acid ester group (—COO—), carboxylic acid amide group (—C(O)NH—), alkenyl ether (—CₓH₂O— where x is 1-10), ether oxygen (—O—) or where vicinal pendant groups provide carboxylic acid imide group [(—C(O))₂N]; A is a C₂-C₁₀ alkylene group or mixtures thereof, preferably a C₂-C₄ alkylene group or mixtures thereof, O represents oxygen atom; R represents a hydrogen atom or a C₁-C₁₀ hydrocarbon (alkyl, aryl alkaryl or the like) group; and n has a value of from about 25 to 100. Preferably, the oxyalkylene groups (AO) provide a majority of the molecular weight of the polymer.

In addition to the polymer units represented by the formula set forth above, the polymer hydrocarbon backbone chain may contain free carboxylic acid anhydride, the free carboxylic acid or its salt pendant groups.

The polymer may be a homopolymer or a copolymer with other copolymerizable units. The copolymerizable monomeric units may be randomly distributed in the polymer structure or may be alternating with the above structure I. Further, the copolymer may contain either one or more than one type of structure shown by the above formula within the polymer structure, and the units may be random or block configuration. Further, the AO chains of any polymer may be made up of a single oxyalkylene (AO) group, such as oxyethylene, oxypropylene or the like, or mixtures of said groups, and said mixture of AO groups may be in block or random configuration.

The molecular weight of the comb polymers suitable in the present invention for modifying cementitious compositions typically have a weight average molecular weight of from about 2,000 to 200,000, preferably from about 2,000 to 100,000 and most preferably from about 2,000 to 75,000. Preferably, although not necessarily, at least about 50, or even up to 90 percent, by weight of the molecular weight of the polymer is attributable to the molecular weight of the AO units therein.

Exemplary polycarboxylate superplasticizers believed suitable for purposes of the present invention are disclosed in U.S. Pat. Nos. 4,946,904; 5,142,036; 5,362,323; 5,393,343; 4,471,100; 5,369,198; and 6,139,623, all of which are incorporated fully herein by reference. U.S. Pat. Nos. 4,946,904 and 5,362,323 disclose maleic anhydride/alkenyl ether comb polymers and their hydrolyzed product wherein the oxyalkylene groups are linked to the backbone polymer chain by an alkenyl ether group. U.S. Pat. No. 5,142,036 discloses a maleic anhydride/alkenyl ether copolymer which further has oxyalkylene groups linked by maleic ester groups. U.S. Pat. No. 5,393,343 discloses polyacrylic acid amide/imide polymers wherein the oxyalkylene chain is linked to the backbone polymer chain by amide groups and vicinal carboxylic acid units which form imide groups. This polymer may further contain unreacted carboxylic acid groups or salts thereof. U.S. Pat. Nos. 4,471,100 and 5,369,198 disclose copolymers which link the oxyalkylene group to the backbone polymer chain by carboxylic acid ester groups.

It will be understood that when an oxyalkylene chain is pendant through a carboxylic acid anhydride (e.g. maleic acid unit) or free carboxylic acid (e.g. acrylic acid unit), not all acid units may be utilized in such linkage and remain as acid units.

Alternately, the comb polymer of the present invention may be a copolymer having a poly(oxyalkylene) backbone wherein carboxylic acid containing units are grafted to the backbone polymer chain. The grafting is normally accomplished by free-radical initiated grafting of ethylenically unsaturated monomers having carboxylic acid groups therein. It is believed (but not intended to limit the scope of the present invention) that the grafting occurs through a secondary carbon atom on the backbone, e.g., one having only one carbon—hydrogen bond. The ethylenically unsaturated carboxylic acid containing monomer, for example, may be acrylic acid, methacrylic acid, itaconic acid and the like as well as their C₁-C₃ alkyl esters. When the poly(oxyalkylene) polymer has hydroxy termination groups, a small degree of esterification between the hydroxyl and carbonyl group may also be present and additional carboxylic acid units be pendant thereupon. Comb polymers of this type are described in U.S. Pat. No. 4,814,014, incorporated herein by reference.

Polycarboxylate superplasticizer polymers contemplated for use in the present invention preferably comprise at least 50% by weight of (poly)oxyalkylene units forming the major component. Thus, the polymer structure of the superplasticizers may contain other copolymerizable units, provided the above preferred requirement is met. For example, the copolymer may further have styrene, methyl vinyl ether, vinyl pyrrolidone and the like, as part of the polymer structure.

In general, the present invention involves adding the viscosity modifying agent (VMA), which is preferably a biopolymer polysaccharide, and most preferably S-657, to the polycarboxylate superplasticizer (“PCS”), wherein the weight of VMA to weight of PCS is no less than 1:100 and no greater than 1:3, and more preferably where the ratio is about 1:6, the VMA being uniformly suspended within said PCS in said first suspension; and forming a second suspension by mixing the first suspension with an aqueous lignosulfonate solution comprising water and a lignosulfonic acid or salt thereof (“LS”), the LS being present in said solution in a concentration of 30% to 70% dry weight, and the aqueous lignosulfonate solution having a volume 1.5-10 times the volume of the first suspension. The first suspension should be fluid and easily pumped, such as with a centrifugal or diaphragm pump. Lignosulfonate is then added to this first suspension to obtain a second suspension, which should preferable have 30%-50% lignosulfonic acid or the salt (lignosulfonate) or derivative thereof, the percentage being determined as a dry weight percentage of the total weight of the second suspension.

Polycarboxylate superplasticizers that are suitable for this invention are available from Grace Construction Products, Cambridge, Mass. under the tradename ADVA®. These polycarboxylate comb polymer solutions may include surface-active agents, and these combinations may have added benefit for the process and composition described herein.

The inventors believe that surface-active agents, either defoamers or air entraining agents, can enhance the ability of the comb polymer to coat the viscosity modifying agent (e.g., biopolymer), thereby inhibiting the rate of hydration. Accordingly, in a further exemplary process of the invention, at least one surface-active agent is incorporated into the first and/or second suspensions. If incorporated into the first suspension, then at least one surface active agent may be added before, during, or after the superplasticizer is combined with the viscosity modifying agent (e.g., biopolymer welan gum, S-657). Exemplary surface-active agents include compositions having the formula (PO)(O—R)₃ wherein R is a C₂-C₂₀ alkyl group, a phosphate ester, an alkyl ester, a borate ester, a silicone derivative, EO/PO type defoamers, esterified fatty acid esters of a carbohydrate (selected from the group consisting of a sugar, sorbitan, a monosaccharide, a disaccharide, and a polysaccharide), a C₂-C₂₀ alcohol containing ethylene oxide and propylene oxide (“EO/PO”) groups, and mixtures thereof. The surface-active agent are preferably present in the second (or resultant suspension) in the amount of 0-5%, based on dry weight percentage of the total weight of the second suspension.

A preferred surface active agent of the present invention has the formula (PO)(O—R)₃ wherein R is a C₂-C₂₀ alkyl group. More preferably, R is a C₃-C₆ alkyl group. Most preferred surface-active agents are antifoaming agents. One preferred agent is is tri-butyl phosphate (e.g., tri-n-butyl phosphate or tri-i-butyl phosphate), which is a hydrophobic oily liquid at ambient temperature. It is believed that other exemplary surface-active agents suitable for use in the invention include phosphate esters (other than tri-butyl phosphate); alkyl esters (e.g., dibutyl phosphate); borate esters; and silicone derivatives (e.g., polyalkyl siloxanes).

Another preferred surface active agent of the present invention comprises an esterified fatty acid ester of a carbohydrate such as a sugar, sorbitan, a monosaccharide, a disaccharide, or polysaccharide. An example is sorbitan monooleate. Another preferred surface-active agent of the invention comprises an alcohol having a chain length of C₂-C₂₀, and more preferably C₁₆-C₁₈, with an EO/PO ratio of less than 1. Suitable surface-active agents of this ethoxylated/propylated alcohol type are available from Huntsman under the tradename SURFONIC (e.g. SURFONIC LF 27 and SURFONIC LF 68) or from BASF under the tradename of PLURONIC (e.g. PLURONIC 25-R2).

Although not critical to the invention, a biocidal agent or preservative may be incorporated into the first and/or resultant suspension. It is believed that known biocidal agents may be employed. The biocidal agent may be present in the second (or resultant suspension) in the amount of 0-2%, based on dry weight of the second suspension. Exemplary biocidal agents include phenol phenolate and 2-methyl-4-isothiazolin-3-one.

The following examples are provided for illustrative purposes only and are not intended to limit the scope of the invention or to limit the exemplary embodiments or variations thereof, which may be evident to those of ordinary skill in view of the present invention disclosure.

### EXAMPLE 1

Samples were made by mixing welan gum or S-657 with a polycarboxylate superplasticizer (e.g., Grace ADVA® brand superplasticizer) in accordance with patent application WO 99/44966 (assigned to Westinghouse Savannah River) to determine if a stable liquid suspension could be formed. The following four mixtures was prepared:

TABLE 1

| | Carbo- | | | |
|---|---|---|---|---|
| | hydrate | ADVA ® | % Carbo- | |
| | grams | grams | hydrate | Mixing Regimen |
| Welan | 16.06 | 125 | 11.4 | 15 minutes with lab mixer at |
| Gum | | | | high speed |
| S-657 | 8.01 | 126.9 | 5.9 | 5 minutes with high-shear |
| | | | | mixer at ˜6000 rpm |
| | 16.03 | 128.7 | 11.1 | 5 minutes with high-shear |
| | | | | mixer at ˜6100 rpm |
| | 8.04 | 126.9 | 6.0 | 5 minutes with high-shear |
| | | | | mixer at ˜6100 rpm |

All solutions separated after about 6 hours with the solid biopolymer settling to the bottom.

### EXAMPLE 2

Welan gum was mixed with combinations of NSFC/MSFC to determine if a stable liquid suspension could be formed:

TABLE 2

| | Carbohydrate | MSFC/NSFC | |
|---|---|---|---|
| | % solids/total | (40% solution) | Stability at 38° C. |
| Welan Gum | 5 | 6/4 | <6 h - separation |
| | 5 | 7/3 | <6 h - separation |
| | 5 | 8/2 | <6 h - separation |
| | 5 | 9/1 | <6 h - separation |

All solutions separated in less than six hours.

### EXAMPLE 3

Biopolymer polysaccharide S-657 was mixed with sodium lignosulfonate using Procedure A without first suspending in the polycarboxylate superplasticizer, and this was compared to mixing using Procedure B.

Procedure A involved the following: 17.5 grams of S-657 was mixed into 54 grams sodium lignosulfonate (50% total solids; 27 grams lignosulfonate solids, 27 grams water) to form a smooth paste/slurry. This paste/slurry was diluted with 315 grams sodium lignosulfonate and 113 grams water to yield a liquid containing 3.5% S-657 and 36.9% total solids.

Procedure B involved the following: 17.5 grams S-657 was mixed into 87.5 grams polycarboxylate superplasticizer (30% total solids; ˜26 grams PCS solids, ˜61 grams water and less than 1 gram surface active agents) to form a paste/slurry (first suspension). This paste slurry (first suspension) was diluted with 307.5 grams sodium lignosulfonate and 87.5 grams water to yield a liquid (a second suspension) containing 3.5% S-657 and 36.0% total solids.

The procedures are summarized below in Table 3.

TABLE 3

| | | Component | Solids | |
|---|---|---|---|---|
| | % Solids | Weight | Weight | |
| PROCEDURE A | in Raw Material | (grams) | (grams) | % TS |
| S-657 | 100% | 17.5 | 17.5 | 3.5% |
| STABILIZER | | | | |
| Sodium | 50% | 54 | 27 | 5.4% |
| Lignosulfonate | | | | |
| CARRIER | | | | |
| Sodium | 50% | 315 | 157.5 | 31.5% |
| Lignosulfonate | | | | |
| Water | 0% | 113 | 0 | 0.0% |
| TOTAL | | 499.5 | 184.5 | 36.9% |
| PROCEDURE B | | | | |
| S-657 | 100% | 17.5 | 17.5 | 3.5% |
| STABILIZER | | | | |
| ADVA ® | 30% | 87.5 | 26.25 | 5.3% |
| CARRIER | | | | |
| Sodium | 50% | 307.5 | 153.75 | 30.8% |
| Lignosulfonate | | | | |
| Water | 0% | 87.5 | 0 | 0.0% |
| TOTAL | | 500 | 180 | 36.0% |

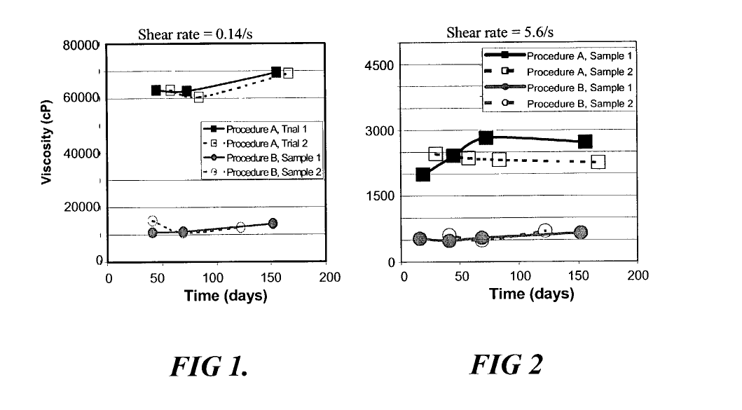

FIG. 1 illustrates the viscosity over time for Procedure A; while FIG. 2 illustrates the viscosity over time for Procedure B. Viscosities were measured at 25° C. at the shear rates indicated. Both at high and low shear, the samples made by Procedure B had significantly lower viscosity. At low shear, which is similar to the conditions of dispensing, the mixture made without first using the polycarboxylate superplasticizer (Procedure A) had a significantly higher viscosity.

Additionally, the mixture made without the polycarboxylate superplasticizer (via Procedure A) increased in viscosity by about 10,000 centipoise (cP) over period of about 100 days; whereas the mixture made with the polycarboxylate superplasticizer (Procedure B) was seen to increase by only about 500 cP over the same time period.

Significantly, at 150 days, the mixtures prepared with the polycarboxylate superplasticizer (Procedure B) were fluid and did not show signs of significant gel formation, whereas the samples made exclusively with lignosulfonate (Procedure A) showed significant gelling, which would be detrimental to dispensing in a commercial application.

### EXAMPLE 4

The use of a polycarboxylate superplasticizer to form a premix (first suspension) of the biopolymer polysaccharide S-657 prevented gelation, as well as agglomeration of individual S-657 particles, which was previously a recurring problem in forming liquid dispersions of S-657. For example, 31.8 kg of S-657 can be evenly dispersed into 166.5 liters of the superplasticizer within 2 hours. To disperse a similar amount of S-657 into lignosulfonate without gelation and particle agglomeration would require at least 8 hours. When dispersion of the S-657 is poor, the sample has a much lower initial viscosity, but develops clumps and a gel-like character, which will lead to poor stability, difficulty in dispensing, and subsequently poor performance as a viscosifying agent.

### EXAMPLE 5

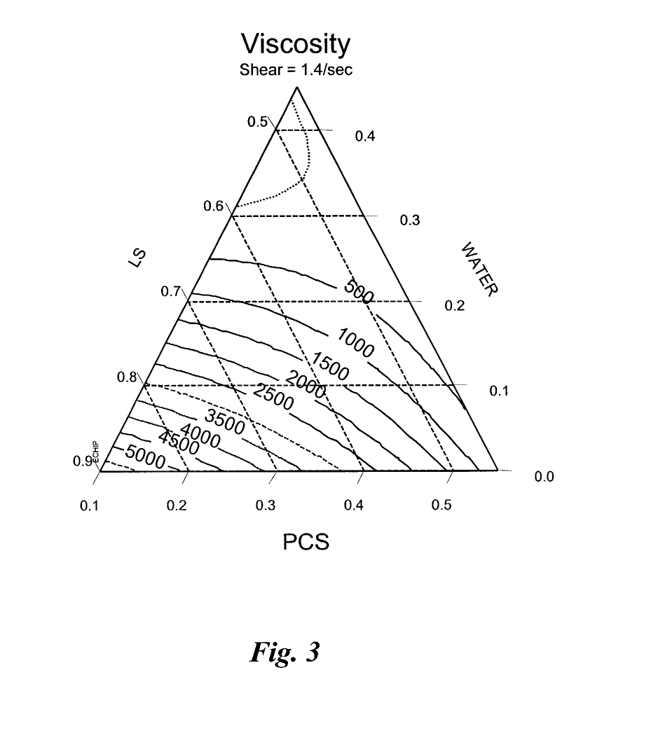

Statistical experimental design has been used to optimize the stability of the suspensions. The results are shown in FIG. 3 as a ternary diagram wherein “LS” represents sodium lignosulfonate. The data indicate that increased polycarboxylate superplasticizer (ADVA®) results in decreased viscosity. By observation, it was determined that mixtures with a viscosity lower than about 1000 centipoise (cP) at a shear rate of 1.4/s were unstable; the solid S-657 would settle to the bottom of the container. From these data, a formula that balances the viscosity and the tendency to separate by settling was chosen:

| | |
|---|---|
| S-657 biopolymer polysaccharide | 3.6 g |
| ADVA ® | 20 g |
| Lignosulfonate solution | 80 g |
| Biocides and Preservatives | trace |
| TOTAL | 103.6 g |

This formulation was prepared as follows: the viscosity modifying agent S-657 was suspended in polycarboxylate superplasticizer (ADVA® brand) with stirring to form a fluid paste/slurry (“first suspension”). Sodium lignosulfonate solution was added to this first suspension with stirring to obtain a second suspension. Biocides and/or preservatives could be added as necessary. Preferably, the concentration of the viscosity modifying agent was held at 3.5% by weight of total formulation. It is thus evident that when the components are combined in this manner to obtain a first suspension and then a second suspension, the resultant composition was superior to compositions wherein the viscosity modifying agent was mixed with lignosulfonate or polycarboxylate solution alone.

While not intending to be constrained by theory, the present inventors surmise that the polycarboxylate superplasticizer acts to coat the individual VMA particles, thereby inhibiting hydration, swelling, and dissolution of the VMA carbohydrate. In the absence of the superplasticizer, it is believed that the VMA particles can hydrate and agglomerate, thereby forming clumps and gels in the formulated material. Slow and continuous hydration of these clumps and gels then leads to an increase in mixture viscosity over time. The additives in Grace's superplasticizer (ADVA® brand), preferably in combination with surface active agents) were deemed to constitute a preferred formulation for this application, and was believed to enhance the interfacial interactions between the superplasticizer and the S-657. This may be a kinetic and/or thermodynamic phenomenon.

The foregoing examples and embodiments are provided for illustrative purposes only and not intended to limit the scope of the invention

We claim:

1. A process for making a suspension having a viscosity modifying agent and water reducing admixtures, comprising:
forming a first suspension by mixing a viscosity modifying agent (“VMA”) and a polycarboxylate superplasticizer (“PCS”) in a ratio wherein weight of VMA to weight of PCS is not less than 1:100 and not greater than 1:3, said VMA being uniformly suspended within said PCS in said first suspension;
forming a second suspension by mixing said first suspension with an aqueous lignosulfonate solution comprising water and a lignosulfonic acid or salt thereof (“LS”), said LS being present in said solution in a concentration no less than 30% dry weight and in a concentration no greater than 70% dry weight, and said aqueous lignosulfonate solution having a volume not less than 1.5 times volume of said first suspension and having a volume not greater than 10 times volume of said first suspension.

2. The process of claim 1 wherein said second suspension has a resultant viscosity not less than 500 cps and final viscosity not greater than 10,000 cps at a shear rate of 1.4/s and a temperature of ˜25° C.; and said viscosity modifying agent is present in said second suspension in a concentration not less than 1.0% and not greater than 5.0% dry weight.

3. The process of claim 1 wherein said second suspension is provided substantially free of visible clumps or gelation of said viscosity modifying agent.

4. The process of claim 1 wherein said viscosity modifying agent comprises at least one of: (a) biopolymer polysaccharides selected from the group consisting of welan gum, S-657, xanthan, rhamsan, gellan, dextran, pullulan, and curdlan; (b) marine gums selected from the group consisting of algin, agar, and carrageenan; (c) plant exudates selected from the group consisting of locust bean, gum arabic, gum Karaya, tragacanth, and Ghatti; (d) seed gums selected from the group consisting of guar, locust bean, okra, psyllium, and mesquite; and (e) starch-based gums selected from the group consisting of ethers, esters, and derivatives thereof.

5. The process of claim 1 wherein said viscosity modifying agent is biopolymer polysaccharide S-657.

6. The process of claim 1 wherein said polycarboxylate superplasticizer is a comb polymer.

7. The process of claim 6 wherein said polycarboxylate superplasticizer comb polymer comprises carboxylic acid groups and oxyalkylene groups.

8. The process of claim 7 wherein said polycarboxylate superplasticizer comb polymer has oxyalkylene pendant groups.

9. The process of claim 1 wherein said polycarboxylate superplasticizer has an average molecular weight of no less than 2,000 and no greater than 200,000.

10. The process of claim 1 further comprising incorporating a biocidal agent into said first suspension, said second suspension, or into both said suspensions.

11. The process of claim 1 further comprising incorporating at least one surface active agent into said first suspension, said second suspension, or into both suspensions.

12. The process of claim 1 wherein said superplasticizer solution comprises a comb polymer structure in the amount of 10-60% by weight in solution.

13. The process of claim 11 wherein said at least one surface active agent is a defoamer.

14. A composition obtained by the process of claim 1.

15. A composition comprising:
an aqueous suspension comprising a viscosity modifying agent (“VMA”), a polycarboxylate superplasticizer (“PCS”), and a lignosulfonic acid or salt thereof,
said VMA comprising at least one of: (a) biopolymer polysaccharides selected from the group consisting of welan gum, S-657, xanthan, rhamsan, gellan, dextran, pullulan, and curdlan; (b) marine gums selected from the group consisting of algin, agar, and carrageenan; (c) plant exudates selected from the group consisting of locust bean, gum arabic, gum Karaya, tragacanth, and Ghatti; (d) seed gums selected from the group consisting of guar, locust bean, okra, psyllium, and mesquite; and (c) starch-based gums selected from the group consisting of ethers, esters, and derivatives thereof;
said PCS comprising a comb polymer having an average molecular weight of no less than 2,000 and no greater than 200,000; and said PCS having carboxylic acid and oxyalkylene groups;
said aqueous suspension having a viscosity not less than 500 cps and final viscosity not greater than 10,000 cps at a shear rate of 1.4/s and a temperature of ˜25° C.; and
said VMA being present in said suspension in a concentration not less than 1.0% and not greater than 5.0% dry weight.

16. A method comprising introducing into a hydratable cementitious composition the second suspension provided by the process of claim 1.

17. A cementitious composition comprising a hydratable cementitious binder, a viscosity modifying agent comprising a biopolymer; a polycarboxylate superplasticizer, wherein the weight of biopolymer to weight of polycarboxylate superplasticizer is not less than 1:100 and not greater than 1:3; and a lignosulfonic acid or salt thereof.
